(19) United States
(12) Patent Application Publication
(10) Pub. No.: US 2007/0297296 A1
(43) Pub. Date: Dec. 27, 2007

(54) Optical disk apparatus

(75) Inventor: Hiroshi Yamagishi, Chiba (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 11/701,870

(22) Filed: Feb. 1, 2007

(30) Foreign Application Priority Data
Jun. 22, 2006 (JP) 2006-172525

(51) Int. Cl. G11B 7/00

(52) U.S. Cl. 369/44.11

(57) ABSTRACT

An optical disk apparatus, suitable for adjusting fluctuation of a light emitted from an optical pickup in the direction thereof, by means of a tilt adjusting mechanism, irrespective of thin-sizing of the housing of the apparatus, comprises within the housing 110, a disk motor 220, a turntable 120, which is rotationally driven by the disk motor, an optical pickup 130, which is attached to be movable into a radial direction of the optical disk “D” loaded, and a tile adjusting mechanism (shafts 230 and 235, adjusting screws 231 and 236, etc.) enabling an adjustment of an inclining angle of the optical pickup with respect to the optical disk, which is loaded onto said turntable, wherein the optical pickup is attached on a chassis 210, which is attached to be in parallel within the housing, together with the tilt adjusting mechanism, and further the disk motor 220 is attached, being inclined by a predetermined angle with respect to the chassis.

### BACKGROUND OF THE INVENTION

The present invention relates to an optical disk apparatus for recording or reproducing information onto/from a disc-like optical recording medium, such as, CD or DVD, etc. (hereinafter, being called by an “optical disk”), and it relates, in particular, to the structures of a thin-type optical disk apparatus equipped with a tilt adjusting mechanism of an optical pickup.

The optical disk apparatus, recording or reproducing information on/from an optical disk, as a recording medium, is widely used to be an information recording apparatus, within various kinds of electronic apparatuses, such as, a personal computer and so on, for example. With such the disk apparatus, demand is strong for the thin-type optical disk apparatus, which can be installed in a narrow space within the personal computer, and for that reason, various measures or devices are made up.

For example, in the following Patent Document 1, also within a small-type disk apparatus, for maintaining a clearance (a gap) between a pickup module and a housing, there is proposed the structures, wherein so-called a pickup module (or a unit mechanism portion), comprising a pickup in a part thereof, a plural number of shafts for holding the said pickup movable in the radial direction of a disk, and a tilt adjusting portion for moving said shafts in the direction perpendicular to the disk surface therein, is installed, inclining only by a predetermined angle with respect to a tray, thereby maintaining such a gap that the above-mentioned tilt adjusting portion can moves therein. However, in this case, since generally the tray moves in horizontal direction within the housing of the apparatus, then the pickup module mentioned above, as is shown in FIG. 3 of that publication, results to be installed, inclining only by the predetermined angle.

[Patent Document 1] Japanese Patent Laying-Open No. 2003-115175 (2003)

### BRIEF SUMMARY OF THE INVENTION

However, with such the structures known by the conventional art mentioned above, with installation of the pickup module mentioned above within the hosing, inclining only by the predetermined angle, it is possible to maintain a gap, in which the tilt adjusting portion within that pickup module can move downwards. However, in general, the tilt adjusting portion is that for achieving such an adjustment, that a light emitting from an optical pickup building up the above-mentioned pickup module enters into, perpendicular to a recording surface of the optical disk loaded, and also the emitting direction of the light from that optical pickup has an angle differing from one another, respectively, in each the pickups, therefore, as was mentioned above, there is a drawback that only maintaining the gap for enabling the tilt adjusting portion to move downwards is not sufficient for adjusting the dispersion in direction of the light emitted from such the pickup.

Then, according to the present invention, accomplished by taking the problems within the conventional art mentioned above into the consideration, an object thereof is to provide an optical disk apparatus having the improved structures, being suitable for adjusting the dispersion or fluctuation of the light emitted from the pickup in the direction thereof, in particular, within a thin-type optical disk apparatus having a tilt adjusting mechanism therein.

Then, according to the present invention, for accomplishing the object mentioned above, firstly, there is provided an optical disk apparatus, comprising at least the followings within a housing thereof: a disk motor; a turntable, which is attached on said disk motor, for rotationally driving an optical disk loaded thereon; an optical pickup, which is attached to be movable into a radial direction of said optical disk loaded; and an angle adjusting mechanism, enabling an adjustment of an inclining angle of said optical pickup with respect to the optical disk, which is loaded onto said turntable, wherein said optical pickup is attached on a chassis, which is attached to be in parallel within said housing, together with said angle adjusting mechanism, and further said disk motor is attached, being inclined by a predetermined angle with respect to said chassis.

Also, according to the present invention, within the optical disk apparatus, as described in the above, preferably, said predetermined angle is from 0.3 to 0.5°, or preferably, thickness of the housing of said apparatus is about 9 mm or less than that.

Further, according to the present invention, within the optical disk apparatus, as described in the above, preferably, a light emitting from said optical pickup is set to incline into a direction of outer periphery of said optical disk loaded, before making adjustment by said angle adjusting mechanism, and further, preferably, a cutoff or a stage-like portion is formed in a part of said housing where said optical disk loaded comes close thereto, or a part of a tray where said optical disk loaded comes close thereto.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a perspective view for showing the entire structures of an optical disk apparatus, according to an embodiment of the present invention, under the condition of removing a top cover thereof;

FIG. 2 is a partial exploded perspective view of a unit mechanism within the optical disk apparatus mentioned above, seeing from a reverse side thereof;

FIG. 3 is a view for explaining the principle of compensating an inclination of an optical pickup, within the optical disk apparatus according to the present invention;

FIGS. 4(a) and 4(b) are cross-section views for showing the structures of attaching the unit mechanism and the condition after a tilt adjusting operation thereof, within the optical disk apparatus according to the present invention;

FIGS. 5(a) and 5(b) are cross-section view for showing the structures of the optical disk apparatus, according to other embodiment of the present invention;

FIGS. 6(a) and 6(b) are perspective views, each for showing the structures of a top case of the optical disk apparatus, according to the other embodiment mentioned above; and

FIG. 7 is a perspective view for showing the structures of a tray of the optical disk apparatus, according to the other embodiment mentioned above.

### DETAILED DESCRIPTION OF THE INVENTION

Hereinafter, embodiments according to the present invention will be fully explained by referring to the attached drawings.

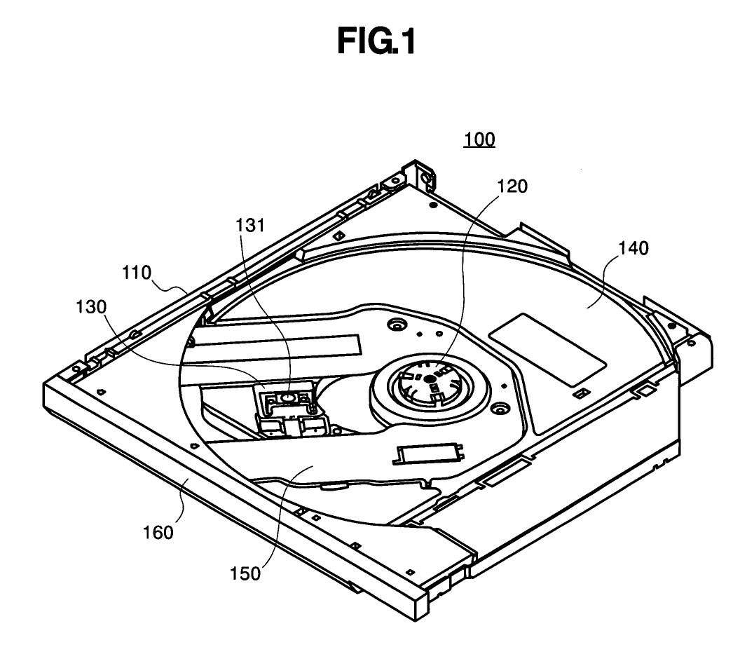

First of all, FIG. 1 attached herewith is a perspective view of the entire of an optical disk apparatus, according to an embodiment of the present invention, seeing from a front side (a disk loading side) thereof, under the condition of removing a top case (not shown in the figure) of a housing thereof. In this FIG. 1, a reference numeral 100 depicts the optical disk apparatus, and within an inside of a thin plate-like housing (i.e., a bottom case) 110; there is provided a turntable 120 for loading (or, fitting) an optical disk to be loaded, on an outer periphery thereof, together with a disk motor, not shown in this figure, for rotationally driving the optical disk, being attached at a tip thereof, an optical pickup 130 including an objective lens 131, etc., in a part thereof, and further, a moving mechanism for enabling the said optical pickup to move in a radial direction of the optical disk loaded, which will be mentioned later. Also, in this figure, a reference numeral 140 depicts a tray of a resin, which is formed to be about disc-like in the shape thereof, for example, and 150 an upper unit cover made from a metal plate, which is provided in an upper portion of a unit mechanism, which will be mentioned below. Also, a reference numeral 160 in the figure depicts a bezel building up a front surface of the optical disk apparatus.

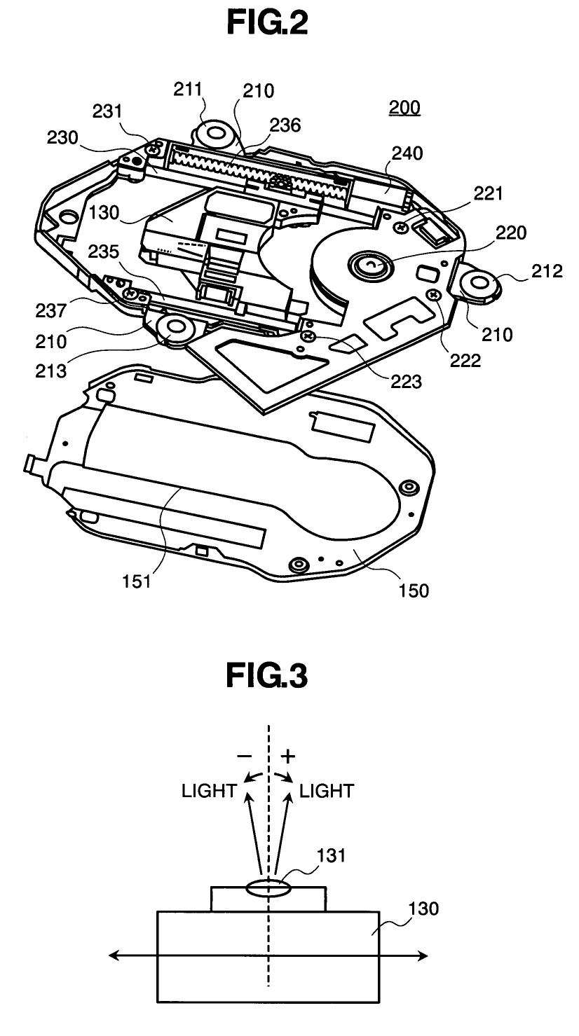

Next, FIG. 2 attached herewith is a perspective view of the unit mechanism 200 mentioned above, seeing from the reverse (under) side surface thereof, and as is apparent from this figure, on a unit mechanism chassis 210 is attached a disk motor 220 for rotationally driving the optical disk, by means of screws 221-223, which are disposed at three (3) positions thereon, for example. Also, on this unit mechanism chassis 210 is attached a pair of shafts 230 and 235, in parallel with each other, which are provided on both side surfaces of the optical pickup 130 mentioned above, facing to each other. Further, in the vicinity of one shaft 230 thereof is disposed a driving shaft 236, on an outer peripheral surface of which is formed a screw groove, in parallel with each other, and accompanying with the rotation thereof, for example, by means of a motor 240 or the like, the optical pickup 130 mentioned above is driven at one end thereof, and thereby moving into the radial direction (see an arrow in the figure) of the optical disk to be loaded. On the other hand, the pair of shafts 230 and 235 mentioned above are so-called guide shafts, and therefore, they guide the said pickup horizontally, while sliding on both ends of the optical pickup 130. Further, at tip portions of the pair of shafts 230 and 235 are provided adjusting screw 231 and 237, respectively, and thereby building up a tilt adjusting mechanism (an angle adjusting mechanism), i.e., for adjusting an inclination of the optical pickup 130 mentioned above, with respect to the optical disk surface. Also, reference numerals 211-213 depict damper portions attached on the housing (or the bottom case) 110 of the unit mechanism 200 mentioned above.

Also, this figure shows the unit mechanism, but under the condition of removing the above-mentioned upper unit cover 150 from it, wherein through an opening portion 151 formed in a central portion thereof, it can be seen that a laser beam emitted from the objective lens 131, which is disposed on a front surface of the optical pickup 130, is incident upon the recording surface of the optical disk, and a reflection light from the recording surface of the optical disk is incident upon the above-mentioned objective lens 131, again, irrespective of movement of the optical pickup. However, though not shown in the figure, within an inside of the housing 110 mentioned above, it is needless to say that there are further provided a signal processing circuit and a controller circuit, etc., which are necessary, other than such the structures as was mentioned above.

Following to the above, FIG. 3 attached herewith shows the side view of the optical pickup mentioned above, and in this figure, as was mentioned above, an arrow shows the direction (see the arrow in FIG. 2 mentioned above), into which the said pickup moves along with the pair of shafts 230 and 235, which are attached in parallel with to each other, while being driven by the driving shaft 236 mentioned above. And, as is shown in the figure, within an inside of the optical pickup 130, not shown in the figure, there are provided an optical system and a driver circuit, etc., which are necessary, together with an light emitting element, such as, a semiconductor laser or the like, for example, and further upon a front (or an upper) surface thereof is incident upon the light emitted from the objective lens 131 mentioned above. Though it is preferable that, as is shown by a broken line in the figure, this emission light is emitted into the direction perpendicular to a moving direction of the optical pickup (or, the front surface of the optical pickup 130) shown by an arrow, however, due to the reasons, such as, fluctuations or the like within the manufacturing processes thereof, in many cases, the light is emitted but being inclined a little bit in front or back thereof, as is shown by an arrow in the figure. However, herein, the clockwise direction in the figure is presented by “+” while the anti clockwise direction by “−”. Further, the fluctuation or dispersion in the emission direction within the optical pickup is about ±1° to 2°, from a result of researches, which are made by the present inventors and so on.

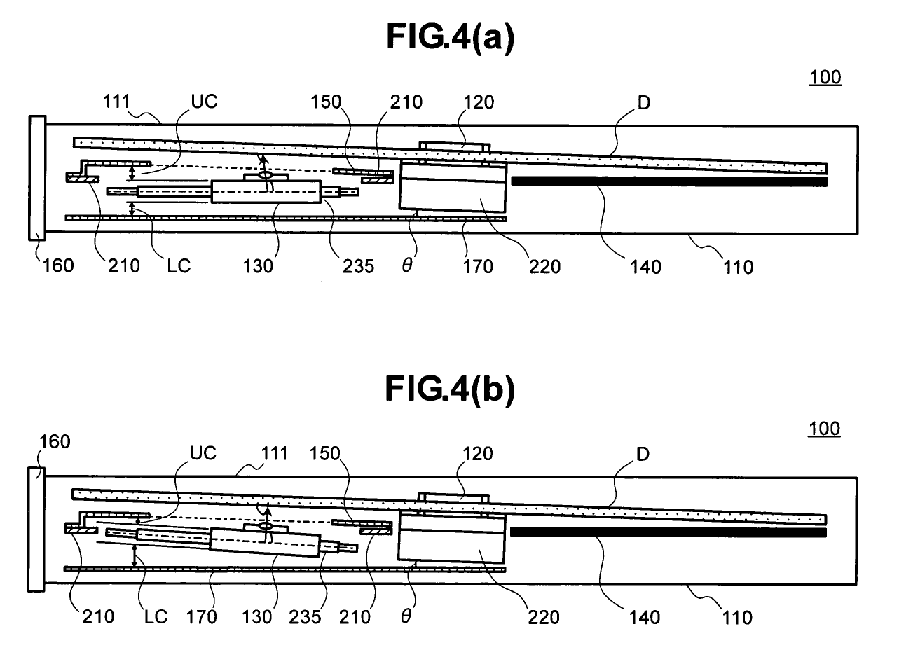

Then, according to the present invention, as is shown in FIG. 4(a) attached herewith, first of all, the disk motor 220 for rotationally driving the optical disk mentioned above is attached, inclining to the unit mechanism 200 shown in FIG. 2 mentioned above. Further, in more details, as is apparent from the figure, it is attached, inclining into the direction of separating from the objective lens 131 of the optical pickup 130, only by an angle of about θ=0.3°-0.5°, for example, with respect to the unit mechanism chassis 210, which builds up a base of the unit mechanism 200. With such the structures, the optical disk “D”, which is inserted into the apparatus, is loaded on the outer periphery of the turntable 120, which is attached at the tip portion of the disk motor 220 mentioned above, also being inclined. Further, in this manner, attaching the disk motor 220, but inclining it only by a predetermined angle, with respect to the unit mechanism 200, in more details, to the unit mechanism chassis 210 thereof, as is apparent from the figure, it is possible, for the tilt adjusting mechanism, which is built up with the pair of shafts 230 and 235 and the adjusting screws 231 and 236, and the optical pickup 130, which is attached to be movable through that tilt adjusting mechanism, to maintain a sufficient gaps (or clearances) UC and LC in an upper and lower portions thereof, on that unit mechanism chassis 210.

Thereafter, as is shown in FIG. 4(b) attached herewith, by means of the tilt adjusting mechanism mentioned above, i.e., the adjusting screws 231 and 236 (see FIG. 2 mentioned above), adjustment is made on the inclination of the optical pickup 130 with respect to the optical disk “D”, in more details thereof, the laser beam emitted from the objective lens 131 of the optical pickup 130 is incident upon the recording surface of the optical disk “D”, vertically or perpendicularly. However, in those figures, a reference numeral 111 depicts a top case of building up another portion of the housing (i.e., the bottom case) of the apparatus, and a reference numeral 170 a lower unit cover made from a thin metal plate, for example, which is provided facing to the upper unit cover 150, within the unit mechanism 200.

Further, according to the present invention, with such the structures as was mentioned above, it is possible to adjust the fluctuation or dispersion in direction of the light emitting from the optical pickup, even within the optical disk apparatus of super thin-type, the width (or thickness) of which is about 9 mm or less than that, easily and within a short time. In addition thereto, according to the present invention, it is preferable to bring the inclination angle of the laser beam, which is emitted from the objective lens 131 of the optical pickup manufactured, as is shown in FIG. 3 mentioned above, to be inclined into “−” side in the figure, for example, always, or the almost thereof, through an improvement on the manufacturing processes or the like. Thus, with doing this, it is sufficient or enough to conduct the adjustment only one (1) direction (i.e., the upper direction in the figure) by the tilt adjusting mechanism shown in FIG. 4(b) mentioned above, thereby making the adjusting operations easy, and further, it is possible to reduce the time for that.

Following to the above, explanation will be made below, on other embodiment, i.e., the optical disk apparatus according to the present invention, the details of which are mentioned above.

Thus, as was mentioned above, with the optical disk apparatus according to the present invention, the disk motor 220 for rotationally driving the optical disk is attached, inclining to the unit mechanism 200, i.e., inclining only by the predetermined angle with respect to the unit mechanism chassis 210. From this, also the optical disk “D” inserted into the apparatus is loaded, being inclined. As a result of this, it can be considered that the optical disk “D” loaded, being inclined, comes to be in contact with an outer periphery portion of the tray 140 and/or an inner periphery or surface of the top case 111, in particular, at a tip portion thereof in the direction of inclination, due to the reason of a warp or deformation of the disc configuration, etc., for example, and thereby being injured on the recording surface of the optical disk, or generating noises (i.e., abnormal sounds), etc.

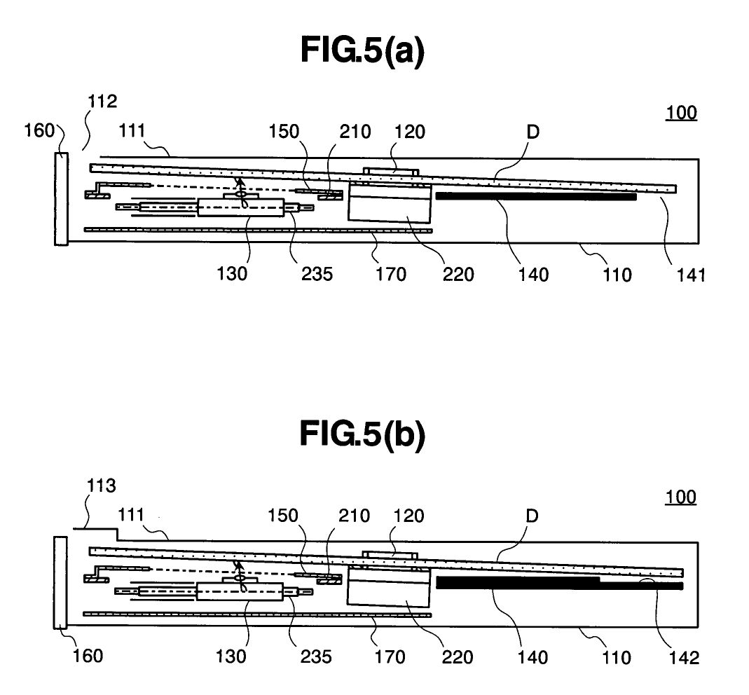

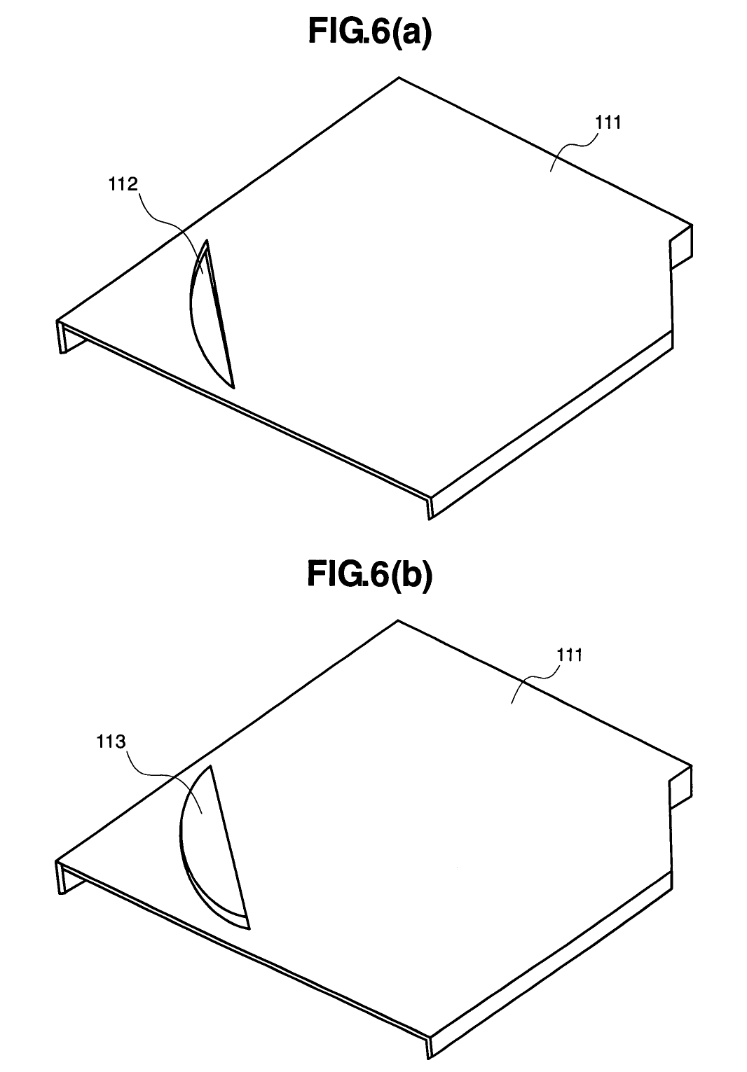

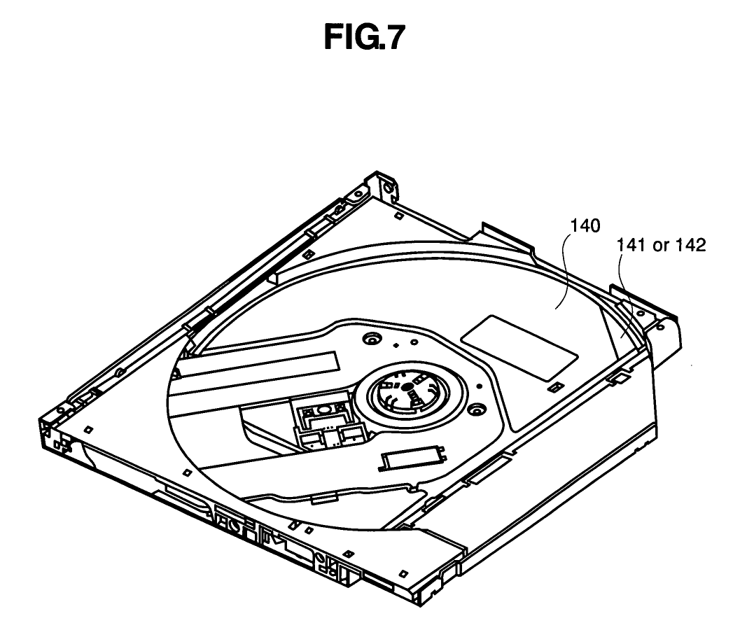

Then, according to the other embodiment of the present invention, as is shown in FIGS. 5(a) and 5(b) attached herewith, a recessed portion of a cutoff portion is formed at the position, having high possibility that the optical disk “D” is in contact with, for dissolving the drawback mentioned above. In more details thereof, for example, as is shown in FIGS. 6(a) and 6(b) attached herewith, for example, a cutoff 112 or a stage-like portion 113 is provided at the portion on the interior surface of the plate-like top case 111, where the tip of the optical disk contacts. Or, together with this, or separately, on the outer periphery portion of the tray 140 is also provided a cutoff 141 or the stage-like portion 142, as is shown in FIG. 7 attached.

However, also with the structures of the optical disk apparatus according to the other embodiment mentioned above, it is possible to adjust the fluctuation or dispersion in direction of the light emitting from the optical pickup, even within the optical disk apparatus of super thin-type, the width (or thickness) of which is about 9 mm or less than that, easily and within a short time, as well as, it is possible to dissolve the drawback due to the contact of the optical disk “D” with a part of the apparatus, accompanying with the inclination of the disk motor 220.

As apparent from the above, according to the present invention, there can be obtained a superior effect of providing an optical disk apparatus having the structures suitable for adjusting the fluctuation or dispersion of the light emitted from the pickup in the direction thereof, in particular, within a thin-type optical disk apparatus having a tilt adjusting mechanism in an inside thereof.

While we have shown and described several embodiments in accordance with our invention, it should be understood that disclosed embodiments are susceptible to changes and modifications without departing from the scope of the invention. Therefore, we do not intend to bound by the details shown and described herein but intend to cover all such changes and modifications as fall within the ambit of the appended claims.

What is claimed is:

1. An optical disk apparatus, comprising at least the followings within a housing thereof:
a disk motor;
a turntable, which is attached on said disk motor, for rotationally driving an optical disk loaded thereon;
an optical pickup, which is attached to be movable into a radial direction of said optical disk loaded; and
an angle adjusting mechanism, enabling an adjustment of an inclining angle of said optical pickup with respect to the optical disk, which is loaded onto said turntable, wherein
said optical pickup is attached on a chassis, which is attached to be in parallel within said housing, together with said angle adjusting mechanism, and further said disk motor is attached, being inclined by a predetermined angle with respect to said chassis.

2. The optical disk apparatus, as described in the claim 1, wherein said predetermined angle is from 0.3 to 0.5°.

3. The optical disk apparatus, as described in the claim 1, wherein thickness of the housing of said apparatus is about 9 mm or less than that.

4. The optical disk apparatus, as described in the claim 1, wherein a light emitting from said optical pickup is set to incline into a direction of outer periphery of said optical disk loaded, before making adjustment by said angle adjusting mechanism.

5. The optical disk apparatus, as described in the claim 1, wherein a cutoff or a stage-like portion is formed in a part of said housing where said optical disk loaded comes close thereto.

6. The optical disk apparatus, as described in the claim 1, further comprising:
a tray, which is formed to face to the optical disk to be loaded, wherein
a cutoff or a stage-like portion is formed in a part of said tray where said optical disk loaded comes close thereto.
